(19) United States
(12) Patent Application Publication
(10) Pub. No.: US 2006/0108472 A1
(43) Pub. Date: May 25, 2006

(54) Control system for an aircraft

(76) Inventor: Walter Dennis Clark, Fulerton, CA (US)

Correspondence Address: LOUIS L. DACHS, 1794 PALISADES DRIVE, PACIFIC PALISADES, CA, 90272, US

(21) Appl. No.: 10/993,497

(22) Filed: Nov. 19, 2004

(51) Int. Cl. B64C 9/00

(52) U.S. Cl. 244/87

(57) ABSTRACT

The invention is a system for controlling an aircraft, the aircraft having a longitudinal axis, vertical and horizontal axis and right and left wings and right and left ailerons mounted on the right and left wings. In detail, the system includes a right stabilizer mounted to the right wing, the right stabilizer canted from the right wing such that the outer end thereof is down and deflectable about an axis of rotation parallel to the span axis of the stabilizer. A left stabilizer is mounted to the left wing, the left stabilizer canted from the left wing such that the outer end thereof is down and deflectable about an axis of rotation parallel to the span axis of the stabilizer. A control system is provided to simultaneously deflect the right aileron and stabilizer downward and the left aileron and stabilizer upward to turn left and to deflect the right aileron and stabilizer upward and the left aileron and stabilizer downward to turn right.

### BACKGROUND OF THE INVENTION

1. Field of the Invention

The invention relates to the field of aircraft control surface systems and, in particular, to a roll control system for an aircraft which eliminates adverse yaw during such maneuvers.

2. Description of Related Art

When ailerons are deflected one goes up as much as the other goes down so there is no net change in the angle of attack of the airplane. The dominant change is the wing's camber. On one side the camber is increased so that the wing lifts more, while on the other, less. The key to understanding adverse yaw is the fact that the wing is already holding the weight of the airplane. With aileron deflection there is a reduced lift on one side and an increased lift on the other. The down-going side is not negative lift, but merely less lift. Any wing that lifts more will always have more drag than the same wing that lifts less. That's how a differential of drag is introduced and it is this differential drag that causes the adverse yaw.

Proverse yaw, yaw going the same direction as roll, is often assumed to be a good thing. Indeed, yaw with the turn can be made faster, or conversely, the surfaces can be made smaller. But yaw in any direction can cause a spin and should therefore be avoided.

This problem has been recognized. For example, U.S. Pat. No. 6,641,086 B2, System And Method For Controlling An Aircraft by W. Clark, the inventor of the present invention, discloses a system wherein two different size ailerons are mounted on each wing. The smaller outermost aileron on one wing moves when the larger innermost aileron on the other side moves. On both sides, the smaller one is arranged to move up when that wing is to go down. Conversely the larger innermost aileron moves down when that side is to go up. This form of asymmetry allows the control surface on the wing that goes down to deflect over a larger angle. With it deflecting over a larger angle it spends most of its time in negative lift. Increasing its negative lift increases its drag. The down-going side hence has drag, which is proverse with roll. The down-going side of normal ailerons does not move as far, so they rarely go into negative lift; merely less positive lift. Less lift means less drag and less drag on the down going side means adverse yaw.

However, this approach has limitations. The ailerons are constrained to move down only. When the roll rate is very low, that is, if the pilot moves the controls laterally only a small amount, the small aileron (even though it deflects farther than the large aileron on the other side) doesn't move far enough to get into negative lift. Although adverse yaw is not a problem at small roll rates, this older invention did not produce cancelled yaw moments. In fact it was only balanced at maximum roll deflections.

Thus, it is a primary object of the invention to provide a control system for an aircraft that eliminates adverse and proverse yaw during all roll maneuvers.

It is another primary object of the invention to provide a control system for an aircraft that eliminates adverse and proverse yaw during roll maneuvers by means of stabilizers; the very same stabilizers that control pitch.

### SUMMARY OF THE INVENTION

The invention is a system for controlling an aircraft, the aircraft having a longitudinal axis, vertical and horizontal axis and right and left wings and right and left ailerons mounted on the right and left wings. In detail, the system includes a right stabilizer mounted to the right wing, the right stabilizer canted downward from the right wing such that the outer end thereof is down and able to deflect about an axis of rotation parallel to the span axis of the stabilizer. A left stabilizer mounted to the left wing, the left stabilizer canted downward from the left wing such that the outer end thereof is down and able to deflect about an axis of rotation parallel to the span axis of the stabilizer. A control system is provided to simultaneously deflect the right aileron and stabilizer downward and the left aileron and stabilizer upward to turn left and to deflect the right aileron and stabilizer upward and the left aileron and stabilizer downward to turn right.

The control system further includes simultaneously deflecting the left and right ailerons downward and the left and right stabilizers upward to create a pitch-up moment and to simultaneously deflect the right and left ailerons upward and the right and left stabilizers downward to create a pitch-down moment. It should be noted that the stabilizers in the process of providing up and down forces also produce drag forces and because of their large lateral displacement from each other can operate as rudders automatically in canceling adverse yaw and by deliberate application of rudder inputs from the pilot's controls.

One embodiment includes a left boom extending rearward from the wing on the left side of the longitudinal axis with the left stabilizer mounted on the end of the left boom. A right boom extends rearward from the wing on the right side of the longitudinal axis with the right stabilizer mounted on its end. In a second embodiment of the invention the stabilizers are mounted on the tips of a swept back wing.

The novel features which are believed to be characteristic of the invention, both as to its organization and method of operation, together with further objects and advantages thereof, will be better understood from the following description in connection with the accompanying drawings in which the presently preferred embodiments of the invention are illustrated by way of examples. It is to be expressly understood, however, that the drawings are for purposes of illustration and description only and are not intended as a definition of the limits of the invention.

### BRIEF DESCRIPTION OF THE DRAWINGS

FIG. 1 is a top view of a tailless (typically called a flying wing) type aircraft in incorporating downward directed stabilizers mounted on the wing tips.

FIG. 2 is a front view of the aircraft shown in FIG. 1.

FIG. 3 is a top view of a conventional aircraft having tail booms mounting stabilizers extending aft from each wing.

FIG. 4 is a rear view of the aircraft shown in FIG. 3

FIG. 5 is a chart showing stabilizer and aileron positions during rolls left and right and pitch changes up and down.

FIG. 6 is a schematic of the control system for the aircrafts shown in FIGS. 1-4.

FIG. 7 is a graph showing the lift curve verses angle of attack (α).

### DESCRIPTION OF PREFERRED EMBODIMENTS

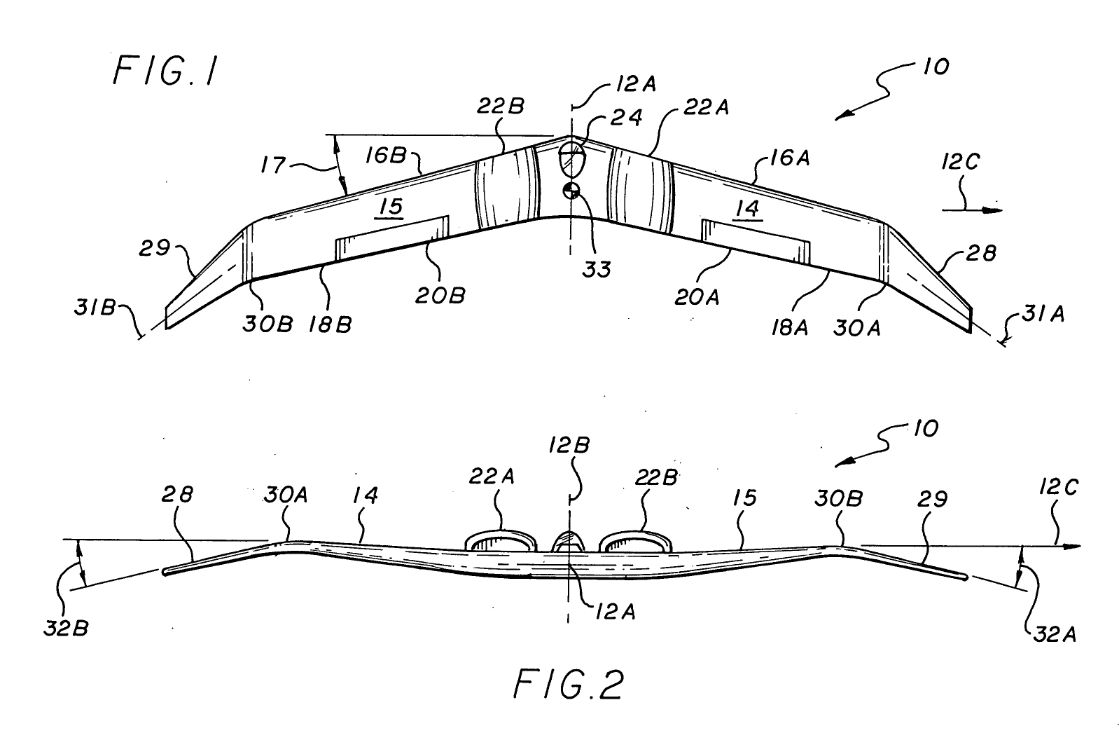

Referring to FIGS. 1 and 2, the tailless aircraft (typically called a flying wing aircraft), generally designated by numeral 10, has a longitudinal axis 12A, vertical axis 12B and lateral axis 12C, right and left wings 14 and 15. The right and left wings 14 and 15 have leading edges 16A and 16B, with a swept angle 17 of approximately 20 degrees, and trailing edges 18A and 18B. Right and left ailerons 20A and 20B are located along the trailing 18A and 18B. Also located in the wings are right and left propulsion systems 22A and 22B. The cockpit 24 is located along the longitudinal axis 12A. Stabilizers 28 and 29 are mounted on the wing tips 30A and 30B, respectively. The stabilizers 28 and 29 are deflectable about axis of rotation 31A and 31B (parallel to the span axis of the stabilizers). The stabilizers 28 and 29 are canted downward at an angle 32A and 32B from the lateral axis 12C. The center of gravity (CG.) is indicated by numeral 33 and thus ailerons 20A and 20B and stabilizers 28 and 29 are all aft of the CG. 33.

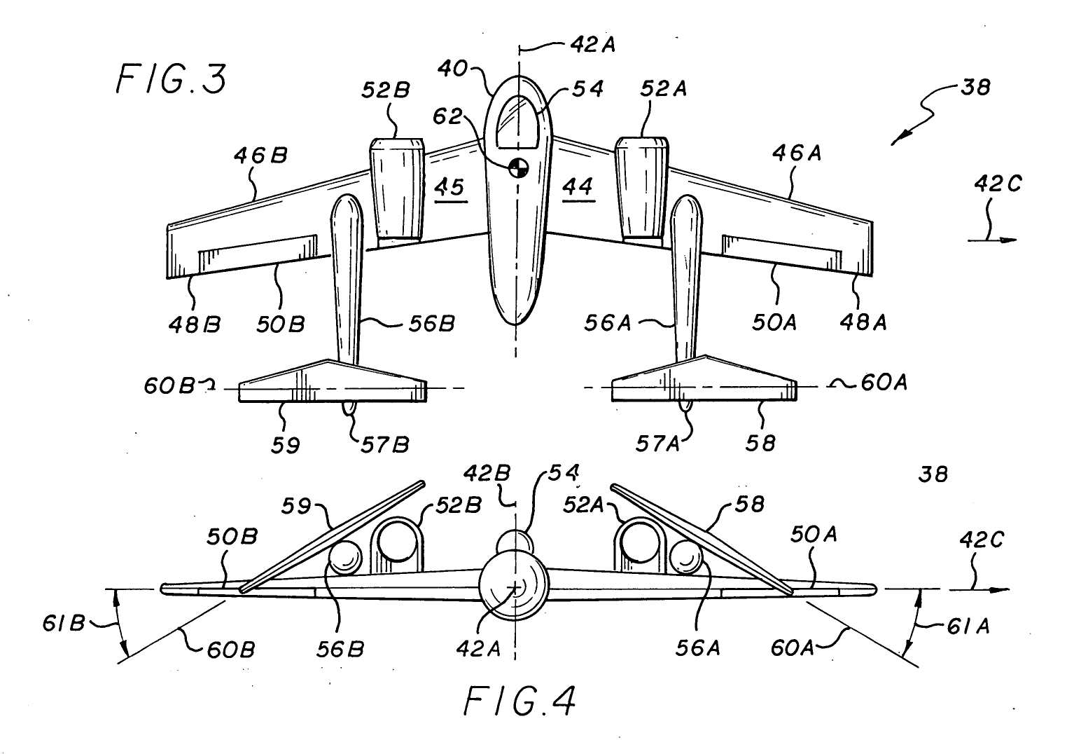

Referring to FIGS. 3 and 4, an aircraft, generally designated by numeral 38, includes a fuselage 40 with a longitudinal axis 42A, vertical axis 42B and lateral axis 42C, right and left wings 44 and 45. The right and left wings 44 and 45 have leading edges 46A and 46B and trailing edges 48A and 48B. Right and left ailerons 50A and 50B are located along the trailing 48A and 48B. Also located in the wings are right and left propulsion systems 52A and 52B. The cockpit 54 is located along the longitudinal axis 42A. Mounted on to the wing and extending from the trailing edges 48A and 48B are booms 56A and 56B extending rearward. Mounted to the ends 57A and 57B of the booms 56A and 56B are stabilizers 58 and 59, respectively. The stabilizers 58 and 59 are deflectable about an axis of rotation 60A and 60B, (parallel to the span axis of the stabilizer). The stabilizers 58 and 59 have a downward cant at an angle 61A and 61B from the lateral axis 42C. Note again that center of gravity, indicated by numeral 62, is forward of the ailerons 50A and 50B and stabilizers 58 and 59.

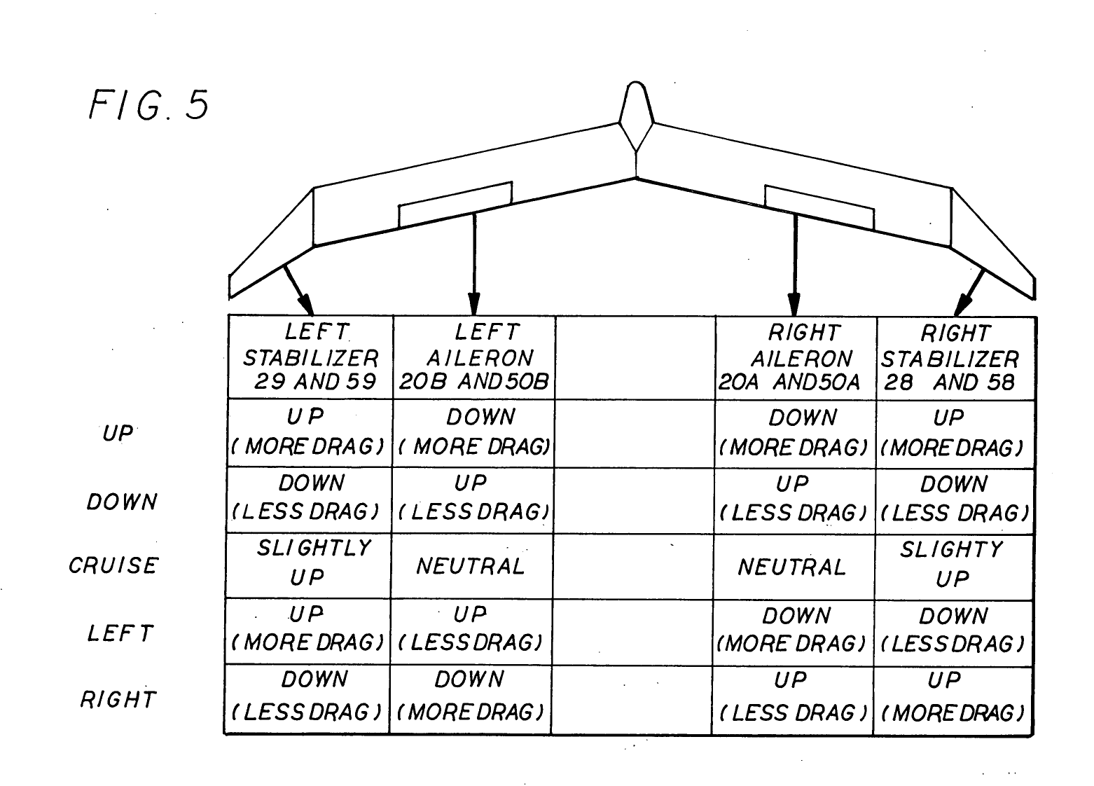

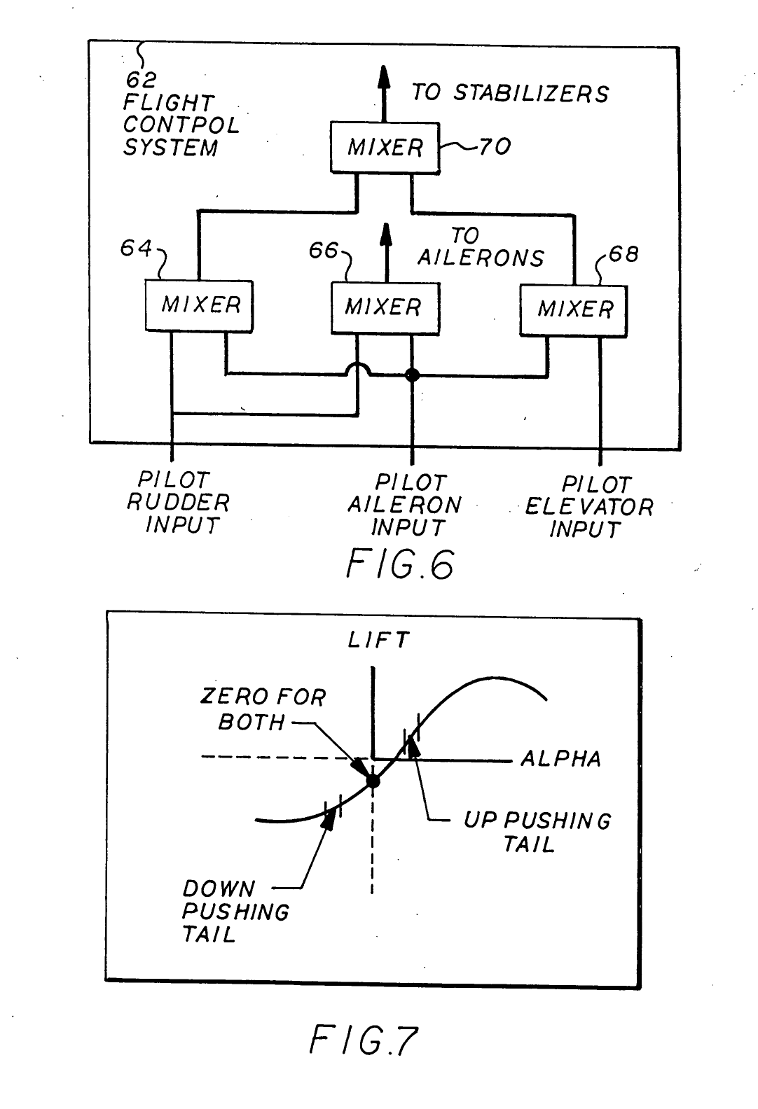

Referring to FIG. 5, required movement of the stabilizers 28 and 29 or 58 and ailerons 20A and 20B, or 50A and 50B to achieve left and right turns, climb, descend and cruise is illustrated. FIG. 6 illustrates how the pilot inputs are mixed. The pilot input for rudder is transmitted via flight management system 62 to the various control surfaces. Within the flight management system 62 are mixers 64 and 66, while pilot roll input it transmitted to mixers 64, 66 and, additionally, to mixer 68 all through a flight management system 69. The output from mixer 66 is transmitted to the aileron control units (not shown). The outputs from mixer 64 and 68 are transmitted to mixer 70. The output from the mixer 50 is transmitted to the stabilizer control units (not shown).

Referring to FIGS. 1-5, the elevator signal is the simplest to understand, in that it affects the stabilizers 28 and 29 or 58 and 59 moving together and ailerons also moving together but opposite to the direction of the stabilizers. They simply go up and down linearly with the fore-aft movement of the control stick (not shown) in the cockpit. For roll control, the ailerons 20A and 20B or 50A and 50B move differentially as would be expected of normal ailerons on any airplane. The stabilizers also move in opposition to each other and in the same direction as the ailerons. The difference is that the stabilizers create proverse yaw while the ailerons create adverse yaw. Proverse yaw and adverse yaw cancel when ailerons and separated-stabilizers are operated together to roll the airplane. When it is desired to create a yaw moment, the proverse yaw of the stabilizers are added to the adverse yaw of the ailerons by having them roll against each other. For example, by making the stabilizers roll left and ailerons roll right, the airplane yaws left with the roll cancelled.

The stabilizers create a roll moment with proverse yaw for two reasons; 1. the stabilizers are normally providing a pitch-up moment and 2. because they are separated from each other laterally. When a stabilizer is said to move up, it is actually moving more up from its normal trim position. And it is not merely moving down but moving less up from its trim position. Moving less up is less drag. More up is more drag. In that way there is a proverse yaw associated with the stabilizers when they assist the ailerons in rolling the airplane.

There is a correctable problem when the stabilizers assist in the rolling of the airplane. On a normal airplane, when ailerons function to roll the airplane, any residual pitch moments are unfelt because the short longitudinal distance from aileron to center of lift. This is not true with stabilizers when they function to roll the airplane. Because the stabilizers are trimmed to provide sufficient pitch-up moment to get the wings to provide lift, when operated differentially from that position, the non-linear characteristics of the control surfaces make the up-going surface less effective (for a given increment of deflection) than the down-going surface, as shown in FIG. 7. The residual force is particularly noticeable if the stabilizers are very far aft of the center of lift. This is corrected by adding mixer 68. The stronger the roll command, the more pitch up is added.

The canceling of adverse yaw of the wing-and-ailerons with the proverse yaw of the separated-stabilizers is achieved through changes in drag as the stabilizer deflects to change its aerodynamic lift force. The drag force on the stabilizers produce a yaw moment because they are separated. This phenomenon exists whether the stabilizers are parallel to the wing or canted down as described above. The canting down provides a vertical component, which will cancel the destabilizing vertical component of the fuselage ahead of the CG. Vertical stabilizers can be used with separated horizontal stabilizers if the increased radar cross-section is acceptable.

While the invention has been described with reference to particular embodiments, it should be understood that the embodiments are merely illustrative as there are numerous variations and modifications which may be made by those skilled in the art. Thus, the invention is to be construed as being limited only by the spirit and scope of the appended claims.

### INDUSTRIAL APPLICABILITY

The invention has applicability to the aircraft industry.

1. A system for controlling an aircraft, the aircraft having a longitudinal axis, vertical and horizontal axis and right and left wings and right and left ailerons mounted on the right and left wings, the system comprising;
a right stabilizer mounted to the right wing, said right stabilizer canted downward from the right wing such that the outer end thereof is down and deflectable about an axis of rotation parallel to the axis of the aircraft;
a left stabilizer mounted to the left wing, said left stabilizer canted downward from the left wing such that the outer end thereof is down and deflectable about an axis of rotation parallel to the span axis of the stabilizer; and
control means to simultaneously deflect the right aileron and stabilizer downward and the left aileron and stabilizer upward to turn left and to deflect the right aileron and left stabilizer upward and the left aileron and stabilizer downward to turn right.

2. The system as set forth in claim 1 wherein the aircraft is a tailless type aircraft, the system comprising:
said right stabilizer mounted on the right tip of the wing; and
said left stabilizer mounted on the left tip of the wing.

3. The system as set forth in claim 1 comprising:
a left boom extending rearward from the left side of the longitudinal axis;
said left stabilizer mounted on the end of said left boom;
a right boom extending rearward from the right side of the longitudinal axis; and
said right stabilizer mounted on the end of said right boom.

4. The system as set forth in claim 1 wherein said control means further includes means to simultaneously deflect the left aileron upward and left stabilizer downward and the right aileron downward and right stabilizer upward to yaw the aircraft to the right and to deflect the right aileron upward and right stabilizer downward and the left aileron downward and left stabilizer upward to affect a yaw moment to the left.

5. A system for controlling an aircraft, the aircraft having a longitudinal axis, vertical and horizontal axis and right and left wings, the system comprising;
right and left ailerons mounted on the right and left wings;
a right stabilizer mounted to the right wing, said right stabilizer canted downward from the right wing such that the outer end thereof is down and deflectable about an axis of rotation parallel to the span axis of the stabilizer;
a left stabilizer mounted to the left wing, said left stabilizer canted downward from the left wing such that the outer end thereof is down and deflectable about an axis of rotation parallel to the span axis of the stabilizer; and
control means to simultaneously deflect said right aileron and stabilizer downward and said left aileron and stabilizer upward to turn left and to deflect said right aileron and stabilizer upward and said left aileron and stabilizer downward to turn right.

6. The system as set forth in claim 5, wherein the aircraft is a tailless type aircraft, the system comprising:
said right stabilizer mounted on the right tip of the wing; and
said left stabilizer mounted on the left tip of the wing.

7. The system as set forth in claim 5, comprising:
a left boom extending rearward from the left side of the longitudinal axis;
said left stabilizer mounted on the end of said left boom;
a right boom extending rearward from the right side of the longitudinal axis; and
said right stabilizer mounted on the end of said right boom.

8. The system as set forth in claim 5 wherein said control means further includes means to simultaneously deflect the left aileron upward and left stabilizer downward and the right aileron downward and right stabilizer upward to yaw the aircraft to the right and to deflect the right aileron upward and right stabilizer downward and the left aileron downward and left stabilizer upward to affect a yaw moment to the left.
